(19) United States
(12) Patent Application Publication
(10) Pub. No.: US 2019/0339772 A1
(43) Pub. Date: Nov. 7, 2019

(54) ELECTRONIC INFORMATION PROCESS SYSTEM AND STORAGE MEDIUM

(71) Applicant: DENSO CORPORATION, Kariya-city (JP)

(72) Inventor: Ichiro YOSHIDA, Kariya-city (JP)

(21) Appl. No.: 16/511,087

(22) Filed: Jul. 15, 2019

Related U.S. Application Data
(63) Continuation of application No. PCT/JP2017/038718, filed on Oct. 26, 2017.

(30) Foreign Application Priority Data
Jan. 18, 2017 (JP) 2017-006728

(51) Int. Cl. G06F 3/01; G10L 25/63

(52) U.S. Cl. CPC G06F 3/015; G06F 3/018; G10L 25/63; G06F 3/013

(57) ABSTRACT

An electronic information process system that includes: an operation acceptance section that accepts an character input operation; a brain activity detection section that detects a brain activity; a gaze direction detection section that detects a gaze direction; a first display controller that displays an accepted character as an input character in a character display field; a presentation necessity determination section that determines whether a presentation of at least one of exchange candidate characters in accordance with the input character is necessary; a second display controller that displays the exchange candidate characters in at least one of exchange candidate display fields; an exchange necessity detection section that determines whether an exchange of the input character for the exchange candidate character is necessary, and selects an exchange target character from the exchange candidate characters; and a character confirmation section that confirms the selected exchange target character as a confirmation character.

### CROSS REFERENCE TO RELATED APPLICATIONS

The present application is a continuation application of International Patent Application No. PCT/JP2017/038718 filed on Oct. 26, 2017, which designated the United States and claims the benefit of priority from Japanese Patent Application No. 2017-006728 filed on Jan. 18, 2017. The entire disclosures of all of the above applications are incorporated herein by reference.

### TECHNICAL FIELD

The present disclosure relates to an electronic information process system and a storage medium.

### BACKGROUND

An electronic information process system can execute various application programs.

### SUMMARY

An electronic information process system may include a presentation necessity determination section that may determine whether a presentation of at least one of multiple exchange candidate characters in accordance with an input character is necessary; a second display controller that may display the multiple exchange candidate characters in at least one of multiple exchange candidate display fields; an exchange necessity detection section that may determine whether an exchange of the input character for the exchange candidate character is necessary, and select an exchange target character from the exchange candidate characters; and a character confirmation section that may confirm the selected exchange target character as a confirmation character.

A computer-readable non-transitory storage medium storing instructions for execution by a computer, the instructions that may cause a controller of an electronic information process system to: determine whether a presentation of at least one of multiple exchange candidate characters in accordance with an input character is necessary; display multiple exchange candidate characters in at least one of multiple exchange candidate display fields; determine whether an exchange of the input character for the exchange candidate character is necessary, and select an exchange target character from the exchange candidate characters; and confirm the selected exchange target character as a confirmation character.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram showing one embodiment;

FIG. 2 is a diagram showing how a user views a display;

FIG. 3 is a flowchart (part 1);

FIG. 4 is a flowchart (part 2);

FIG. 5 is a diagram (part 1) showing a character input screen;

FIG. 6 is a diagram (part 2) showing the character input screen;

FIG. 7 is a diagram (part 1) showing a mode in which an exchange candidate screen is displayed;

FIG. 8 is a diagram (part 2) showing the mode in which the exchange candidate screen is displayed;

FIG. 9 is a diagram (part 3) showing the mode in which the exchange candidate screen is displayed;

FIG. 10 is a diagram (part 4) showing the mode in which the exchange candidate screen is displayed;

FIG. 11 is a diagram (part 5) showing the mode in which the exchange candidate screen is displayed;

FIG. 12 is a diagram (part 3) showing the character input screen;

FIG. 13 is a diagram (part 1) showing a transition of the exchange candidate screen;

FIG. 14 is a diagram (part 2) showing the transition of the exchange candidate screen;

FIG. 15 is a diagram (part 3) showing the transition of the exchange candidate screen;

FIG. 16 is a diagram (part 4) showing the transition of the exchange candidate screen;

FIG. 17 is a diagram (part 5) showing the transition of the exchange candidate screen;

FIG. 18 is a diagram (part 6) showing the transition of the exchange candidate screen;

FIG. 19 is a diagram (part 6) showing the mode in which the exchange candidate screen is displayed;

FIG. 20 is a diagram (part 7) showing the mode in which the exchange candidate screen is displayed;

FIG. 21 is a diagram (part 4) showing the character input screen;

FIG. 22 is a diagram (part 5) showing the character input screen;

FIG. 23 is a diagram (part 8) showing the mode in which the exchange candidate screen is displayed;

FIG. 24 is a diagram (part 9) showing the mode in which the exchange candidate screen is displayed;

FIG. 25 is a diagram (part 10) showing the mode in which the exchange candidate screen is displayed;

FIG. 26 is a diagram (part 11) showing the mode in which the exchange candidate screen is displayed;

FIG. 27 is a diagram (part 12) showing the mode in which the exchange candidate screen is displayed; and

FIG. 28 is a diagram (part 13) showing the mode in which the exchange candidate screen is displayed.

### DETAILED DESCRIPTION

An electronic information process system can execute various application programs. When an application program accepting an operation of character input from a user accepts the operation of the character input by the user, a character that is not intend by the user may be input. For example, it is assumed that an initial setting of a character input type is a one byte alphanumeric input type even when the user intends a hiragana character input. The user performs an operation of the character input, and a one byte alphanumeric character that is not intended by the user is input. In such a case, the user may be needed to perform a tangled operation. The tangled operation is to perform an operation of changing the character input type from in the one byte alphanumeric input type to in the hiragana input type, and to perform an operation of the character input again.

By contrast, there may be a technique that detects, in time series, changes in a magnetic field or an electric field generated by workings of a word center when the user performs the character input operation, and generates a character code of a character which the user intends to input.

It may be assumed that the technique is applied to a difficulty of needing to perform the tangled operation, and thereby the character intended by the user is input. In the technique, it may be necessary to detect, in time series, the changes in the magnetic field or the electric field generated by the workings of the word center. Therefore, it may take a lot of process time until the character intended by the user is input. The technique may not be suitable for the character input for a large number of characters since the character code is generated for each character.

As one example embodiment, an electronic information process system that may include: an operation acceptance section that may accept an character input operation by a user; a brain activity detection section that may detect a brain activity of the user; a gaze direction detection section that may detect a gaze direction of the user; a first display controller that may display an accepted character as an input character in a character display field when the character input operation by the user is accepted; a presentation necessity determination section that may determine whether a presentation of at least one of multiple exchange candidate characters in accordance with the input character is necessary, based on a detection result of the brain activity detection section that is detected after the accepted character by the character input operation by the user is displayed as the input character; a second display controller that may display the multiple exchange candidate characters in at least one of multiple exchange candidate display fields when the presentation necessity determination section determines that the presentation of the exchange candidate characters is necessary; an exchange necessity detection section that may determine whether an exchange of the input character for the exchange candidate character is necessary, and select an exchange target character from the exchange candidate characters when determining that the exchange of the input character for the exchange candidate character is necessary; and a character confirmation section that may confirm the selected exchange target character as a confirmation character when the exchange target character is selected from the exchange candidate characters.

Further, as another example embodiment, a computer-readable non-transitory storage medium storing instructions for execution by a computer of an electronic information process system that includes an operation acceptance section configured to accept a character input operation by a user, a brain activity detection section configured to detect a brain activity of the user, and a gaze direction detection section configured to detect a gaze direction of the user, the instructions configured to cause a controller of the electronic information process system to: accept the character input operation by the user; display an accepted character as an input character in a character display field when the character input operation by the user is accepted; determine whether a presentation of at least one of multiple exchange candidate characters in accordance with the input character is necessary, based on a detection result of the brain activity detection section that is detected after the accepted character by the character input operation by the user is displayed as the input character; display multiple exchange candidate characters in at least one of multiple exchange candidate display fields when determining the presentation of the exchange candidate characters is necessary; determine whether an exchange of the input character for the exchange candidate character is necessary, and select an exchange target character from the exchange candidate characters when determining that the exchange of the input character for the exchange candidate character is necessary; and confirm the selected exchange target character as a confirmation character when selecting the exchange target character from the exchange candidate characters.

A case where the character which is intended by the user is input and a case where the character which is not intended by the user are different in the brain activity of the user, when the user performs the character input operation. When the user performs the character input operation, the electronic information process system determines whether it is necessary to present the exchange candidate character in accordance with the input character based on the detection results of the brain activity of the user and the behavior of the user that are detected after the character input operation. The electronic information process system displays the exchange candidate character. The electronic information process system determines whether it is necessary to exchange the input character for the exchange candidate character based on the gaze direction of the user, the detection results of the brain activity of the user and the behavior of the user. The electronic information process system selects the exchange target character from the exchange candidate characters, and confirms the selected exchange target character as the confirmation character.

It may be possible to select, as the exchange target character, the character intended by the user from the exchange candidate characters and confirm the selected character as the confirmation character by only changing the gaze direction of the user, even when the user does not change the character input type or does not perform the character input operation again. Thereby, it may be possible improve convenience when the user performs the character input operation. This case is different from a case of using changes of the magnetic field or the electric field in time series, the magnetic field or the electric field being generated by the working of a word center. This case does not require a large amount of process time and is suitable for the character input operation including a large amount of characters since this case uses differences of the brain activity of the user.

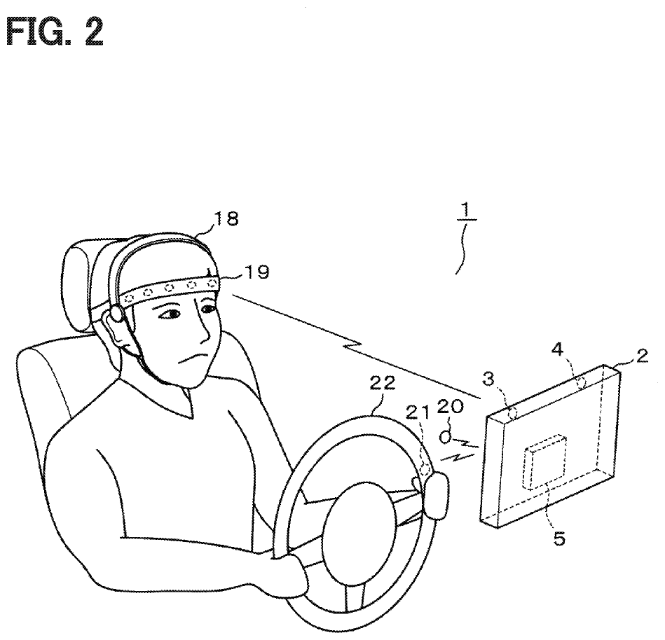

Hereinafter, one embodiment applied to an electronic information process system 1 mounted on a vehicle is described with reference to the drawings. As shown in FIG. 2, the electronic information process system 1 includes a display 2 which can be visually recognized by a user who is a driver in a vehicle compartment. The display 2 is placed at a position where a forward view field of the user is not prevented. In the display 2, two cameras 3 and 4 that photograph a face of the user are placed, and a control unit 5 including each kind of electronic components is incorporated.

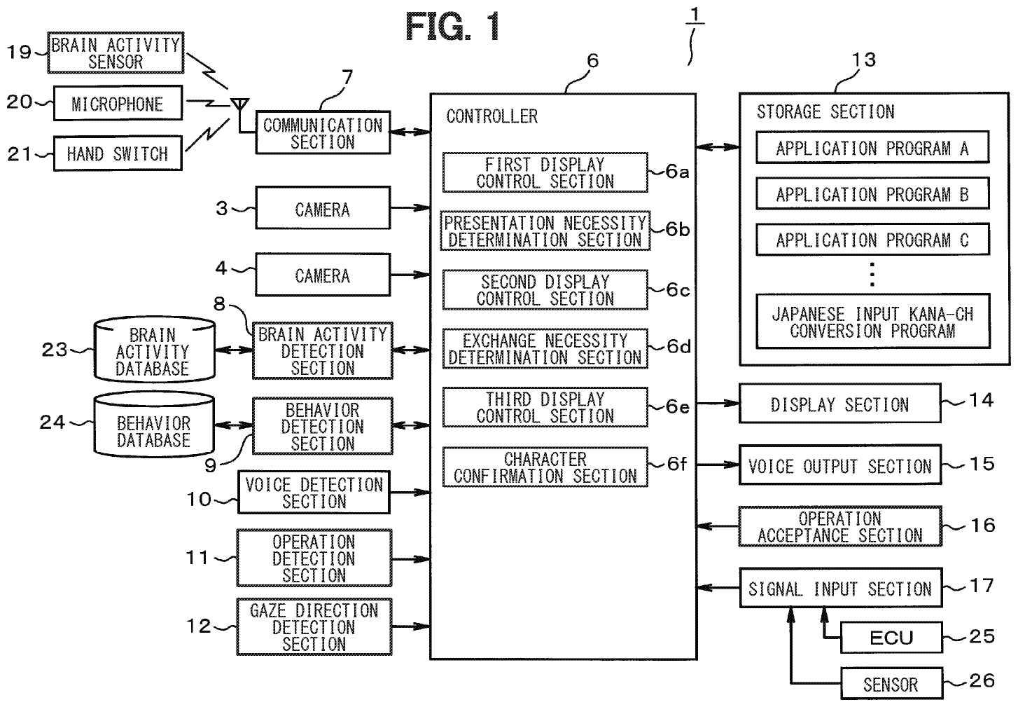

As shown in FIG. 1, the electronic information process system 1 includes a controller 6, a communication section 7, a brain activity detection section 8, a behavior detection section 9, a voice detection section 10, an operation detection section 11, a gaze direction detection section 12, a storage section 13, a display section 14, a voice output section 15, an operation acceptance section 16, and a signal input section 17.

The controller 6 is provided by a microcomputer having a CPU (Central Processing Unit), a ROM (Read Only Memory), a RAM (Random Access Memory), and an I/O device (Input/Output device). The controller 6 executes a computer program stored in a non-transitory tangible storage medium to execute a process in accordance with the computer program, and controls the overall operation of the electronic information process system 1.

The cameras 3 and 4 photograph the substantial entire face of the user, and output a video signal including the photographed video to the controller 6. The communication section 7 performs a near field wireless communication following to a communication standard such as, for example, Bluetooth (registered trademark) or WiFi (registered trademark) among multiple brain activity sensors 19 placed in a headset 18 attached to a head of the user, a microphone 20 collecting the voice uttered by the user, and a hand switch 21 that can be operated by the user. The microphone 20 is placed at a position where the voice uttered by the user is easily collected, for example, such as a peripheral position of a steering 22. The microphone 20 may be attached integrally with the headset 18. The hand switch 21 is placed at, for example, a position where the user easily operate while holding the steering 22.

The brain activity sensor 19 irradiates a near infrared light on a scalp of the user, receives an irregular reflection light of the irradiated near infrared light, and monitors the brain activity of the user. When the near infrared light is irradiated onto the scalp of the user, an optical element of the irradiated near infrared light diffuses into brain tissues due to a high bio-passing capability to pass through skin or bones, and reaches a cerebral cortex about 20 to 30 millimeters deep from the scalp. The brain activity sensor 19 detects the optical element irregularly reflected at a point several centimeters away from an irradiation point due to light absorbing characteristics which differ with respect to oxyhemoglobin concentration and deoxyhemoglobin concentration in blood. By detecting the optical element in the manner as above, the brain activity sensor 19 estimates changes in the oxyhemoglobin concentration and the deoxyhemoglobin concentration at the cerebral cortex. The brain activity sensor 19 transmits a brain activity monitoring signal indicating the estimated changes to the communication section 7. Alternatively, the brain activity sensor 19 may estimate the changes in total hemoglobin concentration, which is a sum of oxyhemoglobin concentration and deoxyhemoglobin concentration at the cerebral cortex, in addition to the oxyhemoglobin concentration and the deoxyhemoglobin concentration at the cerebral cortex. The brain activity sensor 19 may transmit the estimated changes indicating the brain activity monitoring signal to the communication section 7.

Upon detecting the voice uttered by the user, the microphone 20 transmits a voice detection signal indicating the detected voice to the communication section 7. Upon detecting the operation of the user, the hand switch 21 transmits an operation detection signal indicating the detected operation to the communication section 7. Upon receiving each of the brain activity monitoring signal, the voice detection signal, and the operation detection signal from the brain activity sensor 19, the microphone 20, and the hand switch 21, the communication section 7 outputs the received brain activity monitoring signal, the received voice detection signal, and the received operation detection signal to the controller 6. Each of the brain activity sensor 19, the microphone 20, and the hand switch 21 is wirelessly fed, and a wiring of a feeder is unnecessary.

The brain activity detection section 8 detects the brain activity of the user by using a NIRS (Near Infra-Red Spectroscopy) technique. In a brain information process, two systems may be tightly linked to each other. One is a communication system supported by neural activity and the other is an energy supply system supporting the neural activity. At an onset of the neural activity, peripheral blood vessels expand, and an adjustment mechanism supplying a large volume of arterial blood containing oxygen and glucose as an energy source starts to function. It may be hypothesized that an oxidation state of blood (a ratio of oxyhemoglobin concentration to deoxyhemoglobin concentration) changes due to an increase in volume of blood flow and volume of blood in tissue in close proximity to active nerve. Such a relationship between the neural activity and a cerebral blood reaction is called neurovascular coupling. According to the NIRS technique, the brain activity of the user is detected by detecting local hemoglobin concentration in the brain under hypothesis that neurovascular coupling is present.

The communication section 7 receives the brain activity monitoring signal from the brain activity sensor 19. When the received brain activity monitoring signal is input to the controller 6, the brain activity detection section 8 detects the changes in the concentration of the oxyhemoglobin and the concentration of the deoxyhemoglobin based on the input brain activity monitoring signal. The brain activity detection section 8 stores brain activity data obtained by digitalizing the detection result into a brain activity database 23 each time. The brain activity detection section 8 updates the brain activity data stored in the brain activity database 23, and compares the detected brain activity data with the old brain activity data.

The brain activity detection section 8 pre-sets a comfortable threshold and an uncomfortable threshold used as determination criteria based on the brain activity data stored in the brain activity database 23. When a numerical value of the brain activity data is at or above (also referred to as equal to or higher than) the comfortable threshold, the brain activity detection section 8 detects that the user feels comfortable. When the numerical value of the brain activity data is below (also referred to as lower than) the comfortable threshold and at or above the uncomfortable threshold, the brain activity detection section 8 detects that the user feels normal (neither comfortable nor uncomfortable). When the numerical value of the brain activity data is below the uncomfortable threshold, the brain activity detection section 8 detects that the user feels uncomfortable. The brain activity detection section 8 outputs to the controller 6, a detection result signal indicating a detection result of the brain activity of the user detected in this manner as above.

The behavior detection section 9 detects a behavior of the user by using an image analysis technique and a voice recognition technique. When the cameras 3 and 4 input the video signal to the controller 6, the behavior detection section 9 detects a facial movement of the user or a mouth movement of the user based on the input video signal. The behavior detection section 9 stores behavior data obtained by digitalizing the detection result into a behavior database 24 each time. The behavior detection section 9 updates the behavior data stored in the behavior database 24 and compares the detected behavior data with the old behavior data.

The behavior detection section 9 pre-sets a comfortable threshold and an uncomfortable threshold used as determination criteria based on the behavior data stored in the behavior database 24. When a numerical value of the behavior data is at or above the comfortable threshold, the brain activity detection section 8 detects that the user feels comfortable. When the numerical value of the behavior data is below the comfortable threshold and at or above the uncomfortable threshold, the behavior detection section 9 detects that the user feels normal (neither comfortable nor uncomfortable). When the numerical value of the behavior data is below the uncomfortable threshold, the behavior detection section 9 detects that the user feels uncomfortable. The behavior detection section 9 outputs, to the controller 6 a detection result signal indicating a detection result of behavior of the user detected in this manner as above.

The user utters, and the communication section 7 receives the voice detection signal from the microphone 20. When the received voice detection signal is input to the controller 6, the voice detection section 10 detects the voice uttered by the user based on the input voice detection signal. The voice detection section 10 outputs a detection result signal indicating the detected detection result to the controller 6. The user operates the hand switch 21, and the communication section 7 receives the operation detection signal from the hand switch 21. When the received operation detection signal is input to the controller 6, the operation detection section 11 detects the operation by the user based on the input operation detection signal. The operation detection section 11 outputs a detection result signal indicating the detected detection result to the controller 6. When the controller 6 receives the video signal from the cameras 3 and 4, the gaze direction detection section 12 detects the gaze direction of the user based on the input video signal, and the outputs a detection result signal indicating the detection result to the controller 6.

The storage section 13 stores multiple programs that can be executed by the controller 6. The programs stored in the storage section 13 include multiple kinds of application programs A, B, C . . . that can accept the character input by the multiple character input types, and include a Japanese input kana-kanji conversion program. The Japanese input kana-kanji conversion program corresponds to software that performs kana-kanji conversion for inputting Japanese texts. The kana-kanji conversion program may be referred to as a Japanese input program, a Japanese input front end processor (FEP), or a kana-kanji conversion program. The character input type may include a one byte alphanumeric input type, a two byte alphanumeric input type, a one byte katakana input type, a two byte katakana input type, a hiragana input type, or the like. The term of “kanji” may be referred to as “Chinese character (CC)”. Further, the term of “kana-kanji” may be referred to as a term of “kana-CC”.

The display section 14 includes, for example, a liquid crystal display or the like. When the controller 6 inputs a display instruction signal, the display section 14 displays a screen specified by the input display instruction signal. The voice output section 15 includes, for example, a loudspeaker or the like. When the controller 6 inputs a voice output instruction signal, the voice output section 15 outputs the voice specified by the input voice output instruction signal. The operation acceptance section 16 includes a touch panel, a mechanical switch, or the like formed on the screen of the display section 14. When receiving the operation of the character input from the user, the operation acceptance section 16 outputs to the controller 6, a character input detection signal indicating a content of the received operation of the character input. The signal input section 17 inputs each kind of the signals from each of ECUs (electronic control units) 25 or each kind of sensors 26 mounted on the vehicle.

The controller 6 executes each kind of the programs stored in the storage section 13. It is assumed that any application program is being executed. When the character input type of the executed application program is the hiragana input type, the controller 6 also starts the Japanese input kana-kanji conversion program. That is, the controller 6 enables kana character input and further the kana-kanji conversion (that is, conversion from the kana character to the kanji) by activating also the Japanese input kana-kanji conversion program in the hiragana input type.

The controller 6 includes a first display control section 6a, a presentation necessity determination section 6b, a second display control section 6c, an exchange necessity determination section 6d, a third display control section 6e, and a character confirmation section 6f. Each of the sections 6a to 6f includes the computer program executed by the controller 6, and may be provided by the software.

When the operation of the character input by the user is accepted, the first display control section 6a causes the display section 14 to display the accepted character as the input character. When the accepted character by the operation of the character input by the user is displayed as the input character, the presentation necessity determination section 6b determines whether it is necessary to present an exchange candidate character in accordance with the input character based on a detection result of the brain activity detection section 8 and a detection result of the behavior detection section 9, the detection results being detected after the input character is displayed.

When the presentation necessity determination section 6b determines that it is necessary to present the exchange candidate character, the second display control section 6c causes the display section 14 to display the exchange candidate character. When the exchange candidate character is displayed, the exchange necessity determination section 6d determines whether it is necessary to exchange the input character for the exchange candidate character based on a detection result of the gaze direction detection section 12, a detection result of the brain activity detection section 8, and a detection result of the behavior detection section 9, the detection results being detected after the exchange candidate character is displayed. Upon determining that it is necessary to exchange the input character for the exchange candidate character, the exchange necessity determination section 6d selects the exchange target character from the exchange candidate characters.

When the exchange necessity determination section 6d determines that it is necessary to exchange the input character for the exchange candidate character and selects the exchange target character from the exchange candidate characters, the third display control section 6e causes the display section 14 to display the exchange target character instead of the input character. When the exchange target character is selected from the exchange candidate characters, the character confirmation section 6f confirms the selected exchange target character as a confirmation character.

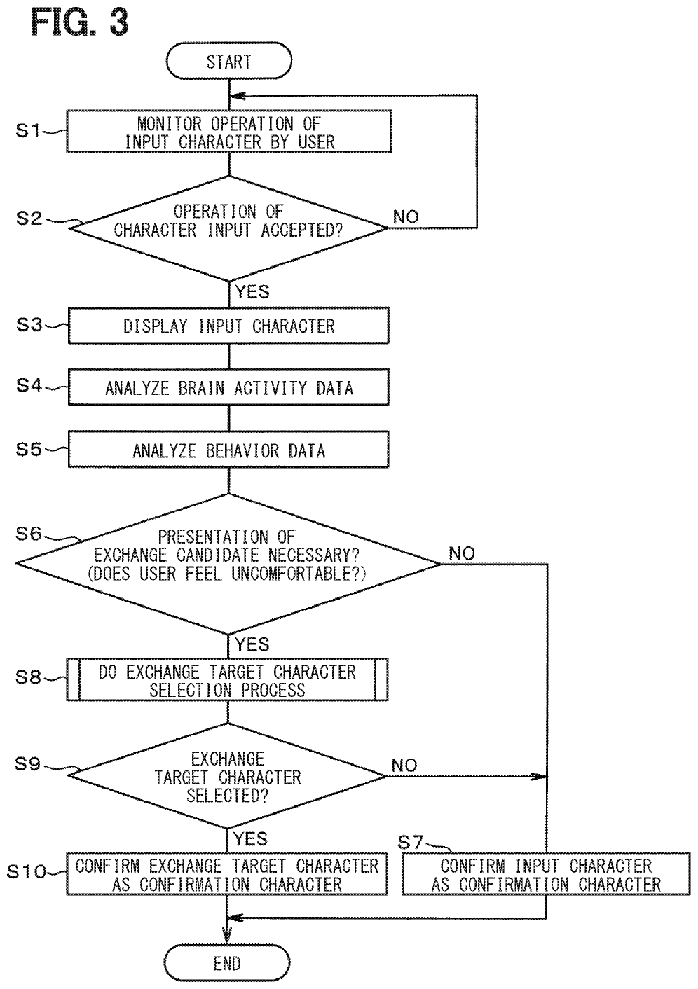

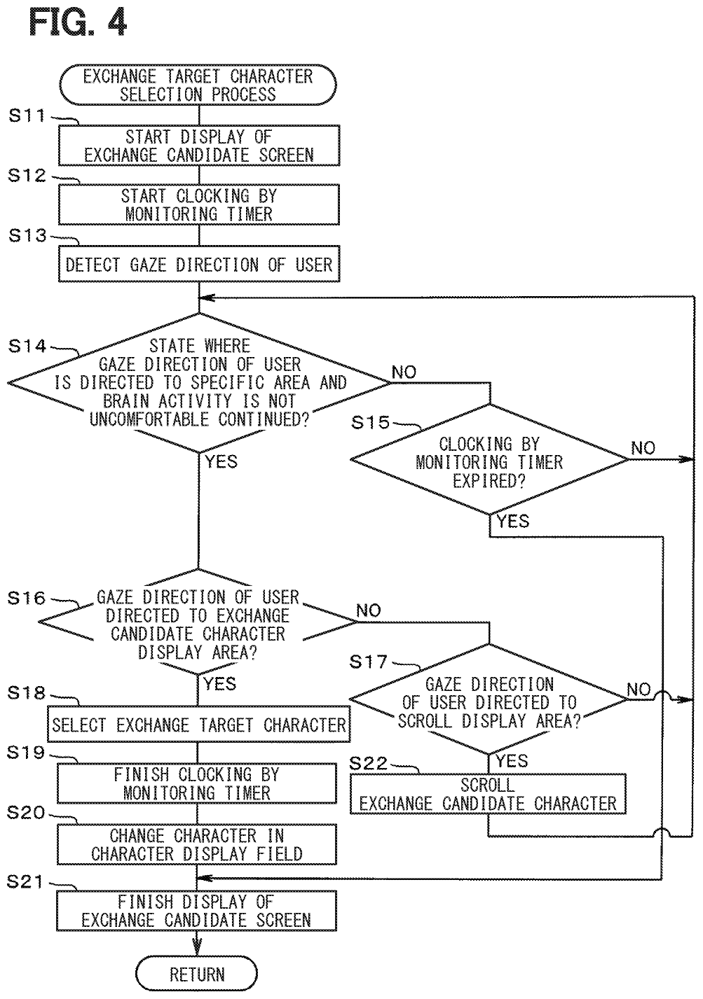

An effect of the configuration will be described with reference to FIGS. 3 to 28.

In the electronic information process system 1, upon starting a character input process, the controller 6 monitors the operation of the character input by the user (S1). The controller 6 determines whether to accept the operation of the character input by the user (S2, corresponding an operation acceptance procedure). Upon inputting the character input detection signal from the operation acceptance section 16 and determining that the operation of the character input by the user is accepted (S2: YES), the controller 6 causes the display section 14 to display, as the input character, the character in accordance with the character input type pre-set at the time (S3, corresponding to a first display control procedure).

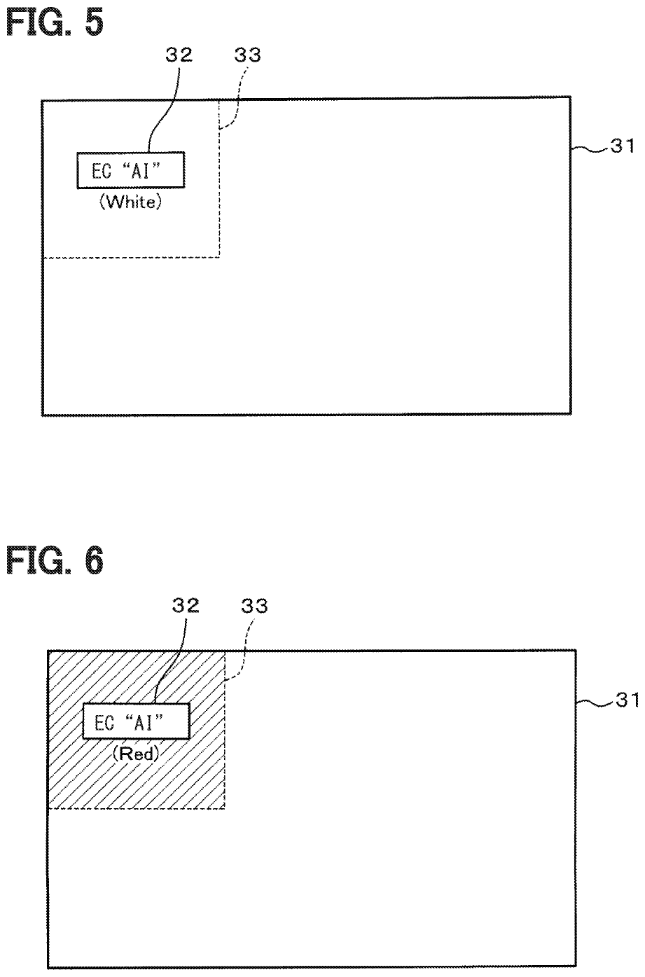

That is, as shown in FIG. 5, when the operation acceptance section 16 accepts the operation of the character input by the user in a state where a character input screen 31 is displayed in the display section 14, the controller 6 displays the accepted character as the input character in a character display field 32. In an example of FIG. 5, it is assumed that, as the operation of the input character by the user, a key of “A” is pressed first, and a key of “I” is pressed second. When the one byte alphanumeric input type is set, the controller 6 displays a term of an EC “AI (in one byte character)” in the character display field 32. The controller 6 displays a background color of a peripheral field 33 that is in a peripheral of the character display field 32, for example, in white color immediately after the input control is displayed in the character display field 32. The English character may be referred to as the EC.

It is assumed that, as the operation of the input character by the user, the key of “A” is pressed first, and the key of “I” is pressed second. When the two byte alphanumeric input type is set, the controller 6 displays the EC “AI (in two byte character)”. The controller 6 displays a KC “ [symbol] (in one byte character)” when the one byte katakana input type is set, and displays the KC “ [symbol] (in two byte character)” when the two byte katakana input type is set, and displays a HC “ [symbol] ” when the hiragana input type is set. When a configuration includes a function of a voice recognition, the user utters and thereby the operation of the character input by the user may be accepted. The user can determine whether to input the character intended by the user by visually recognizing the character displayed in the character display field 32. Furthermore, the katakana character may be referred to as the KC and the hiragana character may be referred to as the “HC”.

The controller 6 analyzes the brain activity data based on the detection result signal input from the brain activity detection section 8 (S4). The controller 6 analyzes the behavior data based on the detection result signal input from the behavior detection section 9 (S5). The controller 6 determines the brain activity of the user and the behavior of the user at the time, that is, emotion immediately after visually recognizing the character input by the character input operation of the user. The controller 6 determines whether it is necessary to present the exchange candidate character (S6, corresponding to a presentation necessity determination procedure).

In the example of FIG. 5, when the user intends to input the one byte alphanumeric character, the user visually recognizes that character in accordance with an intention of the user has been input. Then, the user feels comfortable or normal. The user does not feel uncomfortable, and the changes in the brain activity of the user and the behavior of the user are not activated. By contrast, when the user does not intend to input the one byte alphanumeric character but, for example, the hiragana character, the user visually recognizes that character contrary to the intention of the user has been input. Then, the user feels uncomfortable, and the changes in the brain activity of the user and the behavior of the user are activated.

Upon determining that both of the brain activity data and the behavior data are not below the uncomfortable threshold value and that the user does not feel uncomfortable, the controller 6 determines that it is unnecessary to present the exchange candidate character (S6: NO). The controller 6 confirms the character displayed in the character display field 32 at the time, that is, the input character as the confirmation character (S7). That is, when the user does not feel uncomfortable with the EC “AI (in one byte character)” as the input character input by the character input operation by the user, the controller 6 confirms the EC “AI (in one byte character)” as the confirmation character.

By contrast, upon determining that at least one of the brain activity data or the behavior data are below the uncomfortable threshold value and that the user feels uncomfortable, the controller 6 determines that it is necessary to present the exchange candidate character (S6: YES). As shown in FIG. 6, the controller 6 changes the background color of the peripheral field 33 from white to, for example, red, and shifts to an exchange target character selection process in which the exchange candidate character in accordance with the input character is displayed (S8).

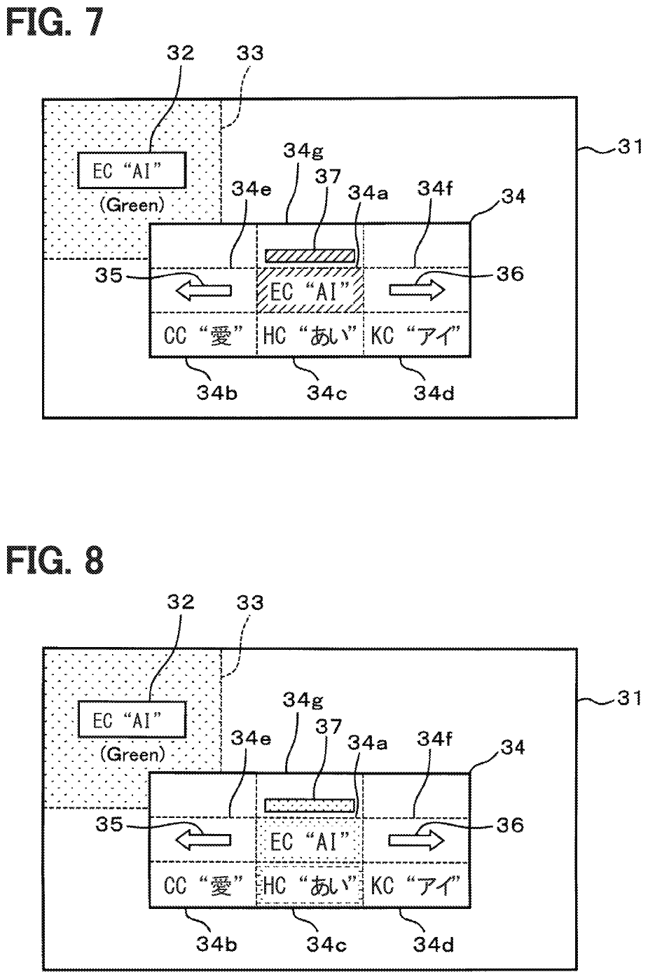

Upon starting the exchange target character selection process, as shown in FIG. 7, the controller 6 changes the background color of the peripheral field 33 from red to, for example, green. The controller 6 starts a pop-up display of an exchange candidate screen 34 on the character input screen 31 (S11, corresponding to a second display control procedure). The controller 6 starts clocking by a monitoring timer (S12). Then, the controller 6 displays the exchange candidate screen 34 at a substantial central part of the character input screen 31. The monitoring timer corresponds to a timer regulating a maximum of a display time of the exchange candidate screen 34. The exchange candidate screen 34 includes an input character area 34a, exchange candidate character areas 34b to 34d (corresponding to exchange candidate display fields), scroll areas 34e and 34f, and an indicator area 34g. The controller 6 displays the character displayed in the character display field 32, that is, the input character in the input character area 34a. The controller 6 displays the exchange candidate character in accordance with the input character in the candidate character areas 34b to 34d. In an example of FIG. 7, the controller 6 displays the EC “AI (in one byte character)” as the input character in the input character area 34a. The controller 6 displays the CC “ [symbol] ”, the HC “ [symbol] ”, the “ [symbol] (in two byte character)” as the exchange candidate character in the candidate character areas 34b to 34d. The controller 6 displays a left arrow icon 35 in the scroll area 34e, displays a right arrow icon 36 in the scroll area 34f, and displays the indicator 37 indicating the emotion in the indicator area 34g. Then, the controller 6 displays the input character area 34a and the indicator 37 in red. The CC “ [symbol] ” means “Love”. The Chinese character may be referred to as the CC.

When popping up the exchange candidate screen 34 to be displayed on the character input screen 31 in this manner, the controller 6 detects the gaze direction of the user based on the detection result signal input from the gaze direction detection section 12 (S13). The controller 6 determines whether, for a predetermined time, a state where a gaze direction of the user is directed to a specific area and also the brain activity of the user and the behavior of the user are uncomfortable continues (S14), and also determines whether to expire the clocking by the monitoring timer (S15).

The controller 6 determines that the state where the gaze direction of the user is directed to the specific area and also the brain activity of the user and the behavior of the user are not uncomfortable continues for the predetermined time before determining that the clocking by the monitoring timer is expired (S14: YES). The controller 6 determines the area (S16, S17, corresponding to an exchange necessity determination procedure).

Upon determining that the area to which the gaze direction of the user is directed corresponds to the exchange candidate character areas 34b to 34d (S16: YES), the controller 6 selects, as the exchange target character, the exchange candidate character belonging to the area to which the gaze direction of the user is directed (S18). The controller 6 finishes the clocking by the monitoring timer (S19). That is, as shown in FIG. 8, the controller 6 selects the HC “ [symbol] ” belonging to the exchange candidate character area 34c as the exchange target character when the area to which the gaze direction of the user is directed corresponds to the exchange candidate character area 34c. Then, the controller 6 displays the exchange candidate character area 34c, for example, in yellow, and changes color of the input character area 34a and the indicator 37 from red to green.

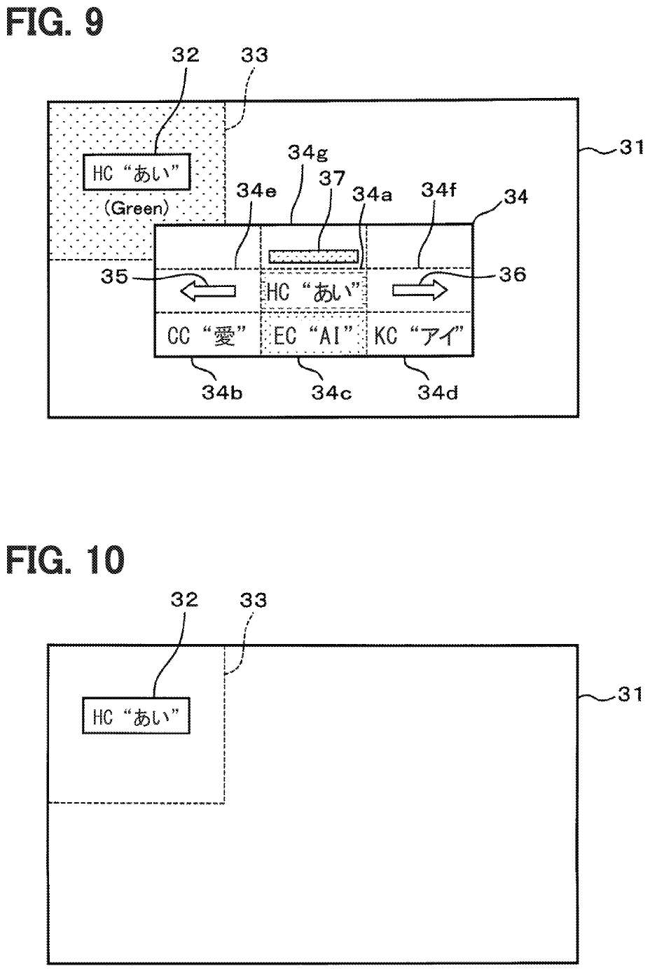

As shown in FIG. 9, the controller 6 exchanges the HC “ [symbol] ” belonging to the exchange candidate character 34c selected as the exchange target character for the EC “AI (in one byte character)” belonging to the input character area 34a. Then, the controller 6 changes the color of the input character area 34a from green to yellow, and changes the color of the exchange candidate character area 34c from yellow to green. The controller 6 changes the character displayed in the character display field 32 from the EC “AI (in one byte character)” to the HC “ [symbol] ” (S20).

As shown in FIG. 10, the controller 6 changes the background color of the peripheral field 33 from green to white (that is, returns to white), and finishes the pop-up display of the exchange candidate screen 34 on the character input screen 31 (S21). The controller 6 ends the exchange target character selection process, and returns to the character input process. According to the processes, by only keeping to direct the gaze direction to the desired exchange candidate character for the predetermined time, the user can change the character displayed in the character display field 32 to the desired exchange candidate character without operating the character input.

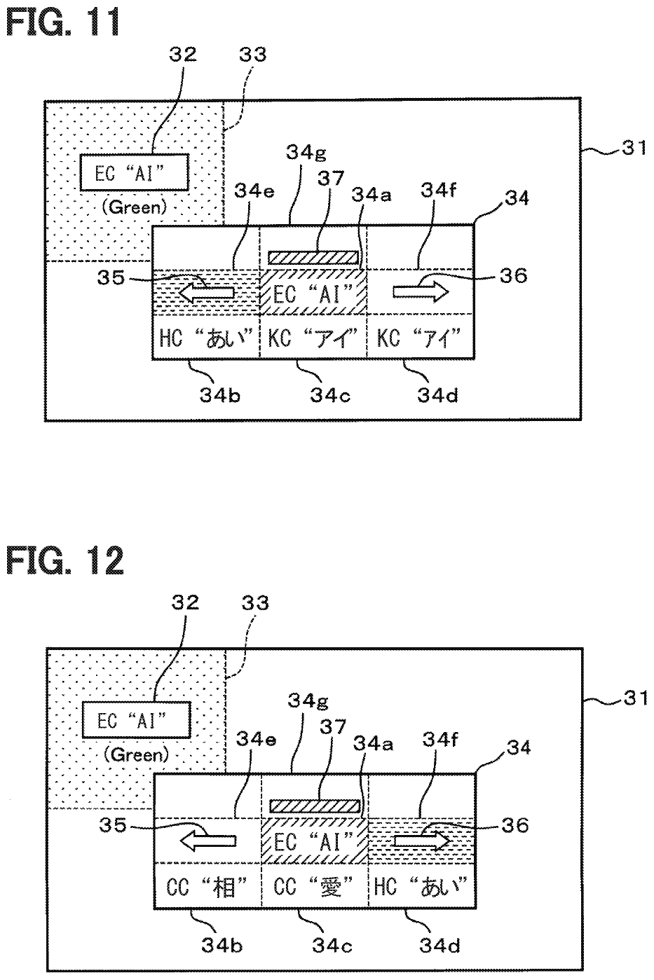

By contrast, upon determining that the area to which the gaze direction of the user is directed corresponds to the scroll areas 34 and 34f (S17: YES), the controller 6 performs a scroll display (in other words, the controller 6 scrolls) the exchange candidate character (S22). The controller 6 returns to the processes of S14 and S15. That is, as shown in FIG. 11, when the area to which the gaze direction of the user is directed corresponds to the scroll area 34e, the controller 6 scrolls in the left direction, the exchange target characters belonging to the exchange candidate character areas 34b to 34d. The controller 6 displays the HC “ [symbol] ”, the KC “ [symbol] (in two byte character)”, and the KC “ [symbol] (in one byte character)” in the exchange candidate character areas 34b to 34d. As shown in FIG. 12, when the area to which the gaze direction of the use is directed corresponds to the scroll area 34e, the controller 6 scrolls, in a right direction, the exchange target characters belonging to the exchange candidate character areas 34b to 34d. The controller 6 displays a CC “ [symbol] ”, the CC “ [symbol] ”, and the HC “ [symbol] ” in the exchange candidate character areas 34b to 34d. The CC “ [symbol] ” means, for example, “Mutually”.

Hereinafter, similarly, upon determining that the area to which the gaze direction of the user is directed corresponds to the exchange candidate character areas 34b to 34d, the controller 6 selects, as the exchange target character, the exchange candidate character belonging to the area to which the gaze direction of the user is directed. According to the processes, the user can display the desired exchange candidate character by only keeping to direct the gaze direction to the left arrow icon 35 or the right arrow icon 36 for the predetermined time even when the desired exchange candidate character is not displayed. Hereinafter, similarly, by only keeping to direct the gaze direction to the desired exchange candidate character for the predetermined time, the user can change the character displayed in the character display field 32 to the desired exchange candidate character without operating the character input.

Upon determining that the area to which the gaze direction of the user does not correspond to any of the exchange candidate character areas 34b to 34d and the scroll areas 34 and 34f (S16: NO, S17: NO), the controller 6 returns to the steps S14 and S15.

When the controller 6 determines that the clocking by the monitoring timer is expired before determining that the state where the area to which the gaze direction of the user is directed to the specific area and also the brain activity of the user and the behavior of the user are not uncomfortable continues for the predetermined time (S15: YES), the controller 6 finishes the pop-up display of the exchange candidate screen 34 without selecting the exchange target character (S21). The controller 6 finishes the exchange target character selection process, and returns to the character input process.

Upon returning to the character input process, the controller 6 determines whether the exchange target character is selected in the exchange target character selection process (S9). Upon determining that the exchange target character is selected (S9: YES), the controller 6 confirms the selected exchange target character as the confirmation character (S10, corresponding to a character confirmation procedure), and finishes the character input process. That is, when the user feels uncomfortable with the input character the EC “AI (in one byte character)” input by the character input operation of the user and the user selects, for example, the HC “ [symbol] ” as the exchange target character by deciding the gaze direction in the exchange candidate screen 34, the controller 6 confirms, as the confirmation character, the HC “ [symbol] ” selected as the exchange target character.

By contrast, upon determining that the exchange target character is not selected (S9: NO), the controller 6 confirms the character displayed in the character display field 32, that is, the input character as the confirmation character (S7), and finishes the character input process. That is, when the user does not select the exchange target character without deciding the gaze direction in the exchange candidate screen 34, the controller 6 confirms the input character as the confirmation character.

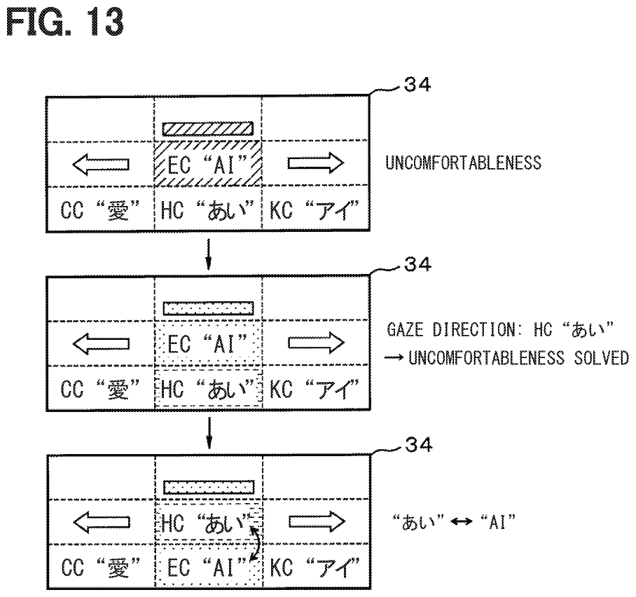

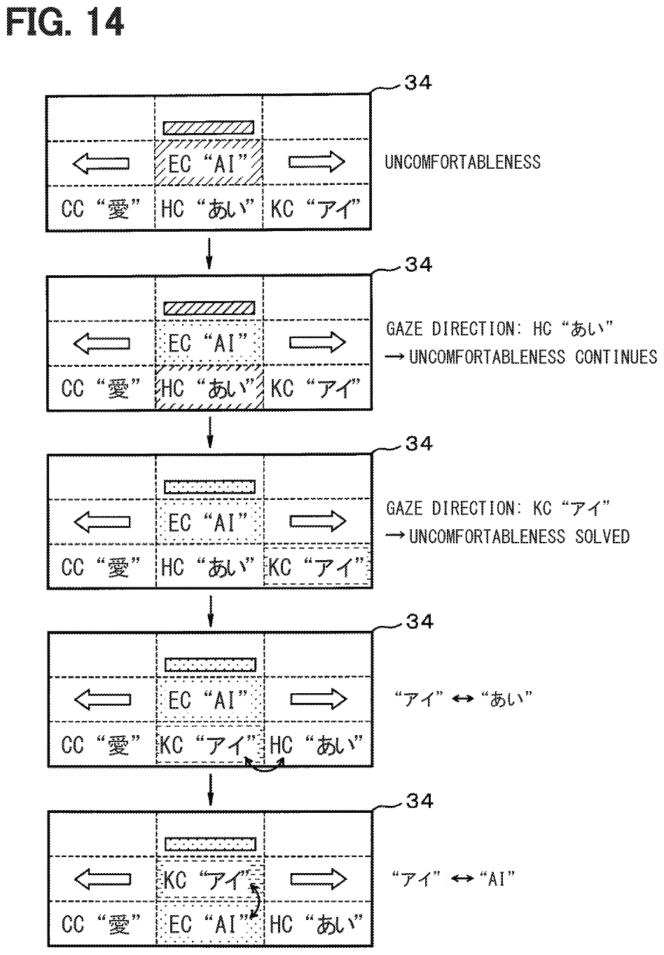

The controller 6 confirms the confirmation character as following by executing the processes as above. It is assumed that the user intends the character input of the HC “ [symbol] ”. As shown in FIG. 13, upon determining that the state where the gaze direction of the user is directed to the HC “ [symbol] ” and also the brain activity of the user and the behavior of the user continue are not uncomfortable continues for the predetermined time, the controller 6 exchanges the EC “AI (in one byte character)” for the HC “ [symbol] ”, and confirms the HC “ [symbol] ” as the confirmation character. It is assumed that the user intends the character input of the KC “ [symbol] (in two byte character)”. As shown in FIG. 14, the controller 6 does not confirm HC “ [symbol] ” as the confirmation character even when the gaze direction of the user is directed to the HC “ [symbol] ”. Upon determining that the state where the gaze direction of the user is directed to the KC “ [symbol] (in two byte character)” and also the brain activity of the user and the behavior of the user are not uncomfortable continues for the predetermined time, the controller 6 exchanges the KC “ [symbol] (in two byte character)” for the HC “ [symbol] [symbol] ”. The controller 6 exchanges the KC “ [symbol] (in two byte character)” for the EC “AI (in one byte character)”, and confirms the KC “ [symbol] (in two byte character)” as the confirmation character.

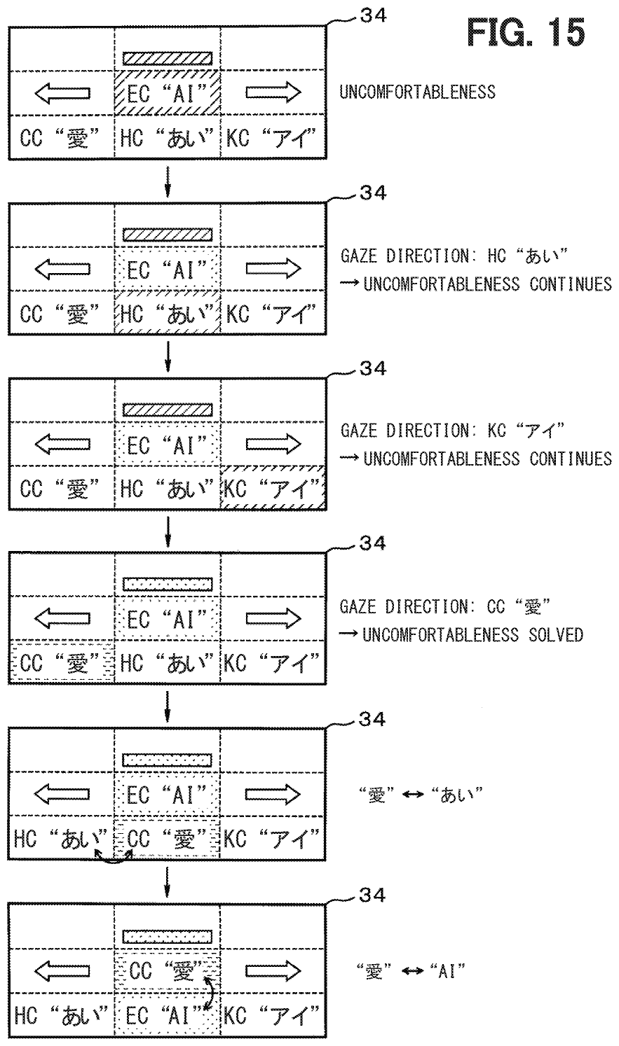

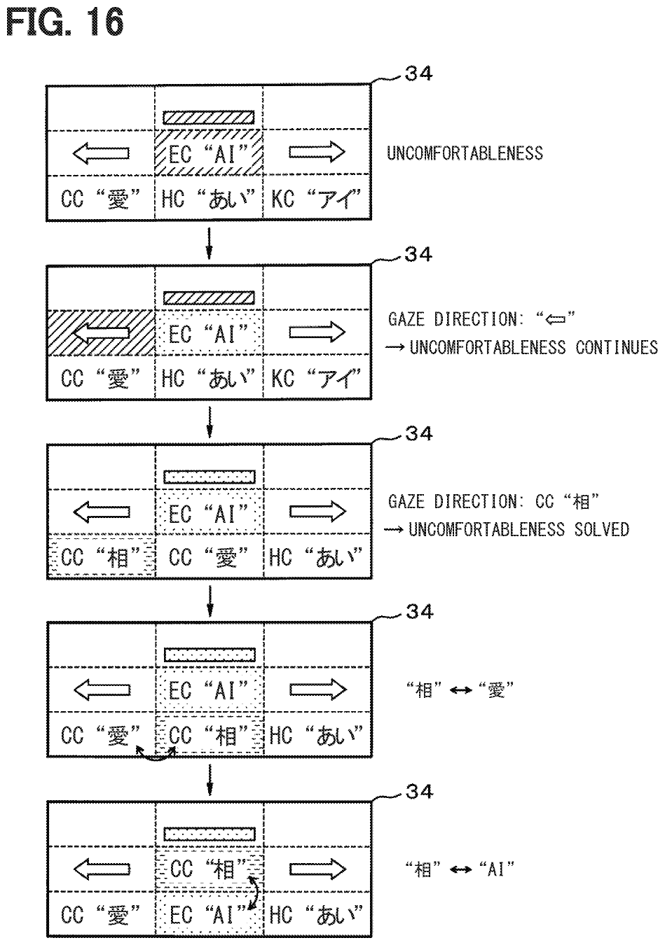

It is assumed that the user intends the character input of the CC “ [symbol] ”. As shown in FIG. 15, the controller 6 does not confirm the HC “ [symbol] ” or the KC “ [symbol] ” as the confirmation character even when the gaze direction of the user is directed to the HC “ [symbol] ” or the KC “ [symbol] ”. Upon determining that the state where the gaze direction of the user is directed to the CC “ [symbol] ” and also the brain activity of the user and the behavior of the user are not uncomfortable continues for the predetermined time, the controller 6 exchanges the CC “ [symbol] ” for the HC “ [symbol] ”. The controller 6 exchanges the CC “ [symbol] ” for the EC “AI (in one byte character)”, and confirms the CC “ [symbol] ” as the confirmation character. It is assumed that the user intends the character input of the CC “ [symbol] ”. As shown in FIG. 16, upon determining that the state where the gaze direction of the user is directed to the left arrow icon 35 and also the brain activity of the user and the behavior of the user continue are not uncomfortable continues for the predetermined time, the controller 6 scrolls the exchange candidate characters and displays the CC “ [symbol] ”. Upon determining that the state where the gaze direction of the user is directed to the CC “ [symbol] ” and also the brain activity of the user and the behavior of the user are not uncomfortable continues for the predetermined time, the controller 6 exchanges the CC “ [symbol] ” for the HC “ [symbol] ”. The controller 6 exchanges the CC “ [symbol] ” for the EC “AI (in one byte character)”, and confirms the CC “ [symbol] ” as the confirmation character.

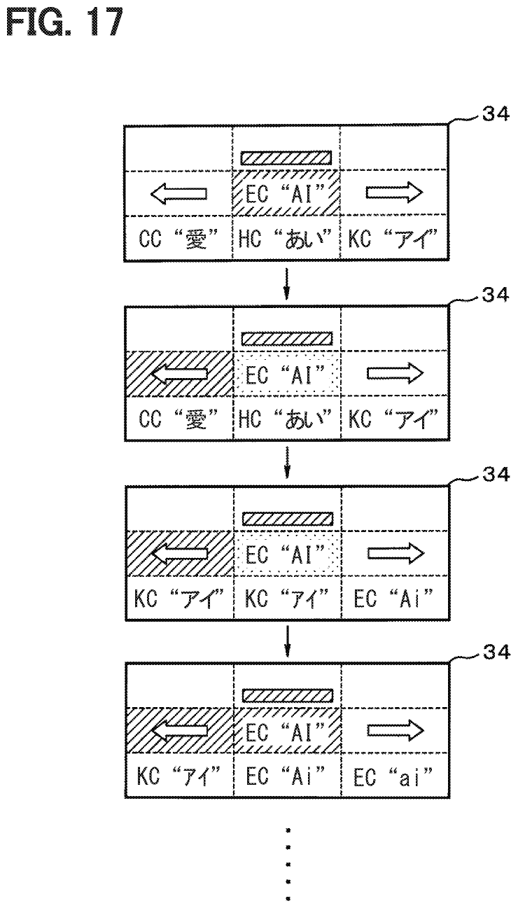

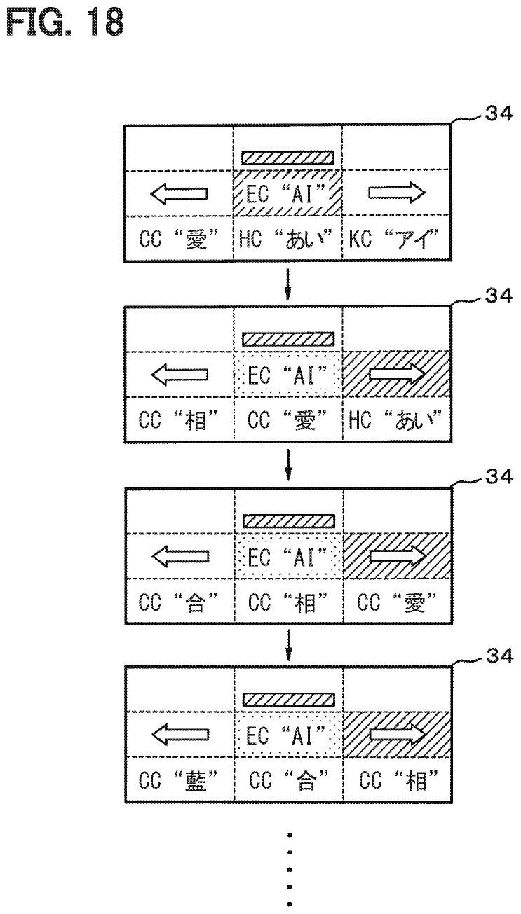

FIG. 17 shows scrolling by the left arrow icon 35. The controller 6 scrolls the exchange candidate characters in the left direction as a time when the gaze direction of the user is directed to the left arrow icon 35 becomes longer. For example, the controller 6 sequentially displays the KC “ [symbol] (in one byte character)”, an EC “Ai (in one byte character)”, an EC “ai (in one byte character)” or the like. FIG. 18 shows scrolling by the right arrow icon 36. The controller 6 scrolls the exchange candidate characters in the right direction as a time when the gaze direction of the user is directed to the right arrow icon 36 becomes longer. For example, the controller 6 sequentially displays the CC “ [symbol] ”, a CC “ [symbol] ”, a CC “ [symbol] ” or the like. The “ [symbol] ” means, for example, “Conjunction”. The “ [symbol] ” means, for example, “Indigo”. The CC “ [symbol] ”, the HC “ [symbol] ”, the KC “ [symbol] ”, the CC “ [symbol] ”, the CC “ [symbol] ”, the CC “ [symbol] ” have the same pronounce of an English character “AI”.

In the above, it is described that the controller 6 determines the brain activity of the user and the behavior of the user, and determines whether it is necessary to present the exchange candidate character. However, the controller 6 may determine utterance by the user or the operation of the hand switch 21 by the user, and may determine whether it is necessary to present the exchange candidate character. That is, upon determining that the user performs utterance of, for example, “Present exchange candidate characters” or the like, or performs a predetermined operation of the hand switch 21, the controller 6 may determine that it is necessary to present the exchange candidate character.

In the above, it is described that the controller 6 determines the brain activity of the user and the behavior of the user and determines whether it is necessary to exchange the input character for the exchange candidate character. However, the controller 6 may determine the utterance by the user or the operation of the hand switch 21 by the user, and may determine whether it is necessary to exchange the input character for the exchange candidate character. That is, upon determining that the user performs the utterance of, for example, “Exchange for the character” or the like, or performs the predetermined operation of the hand switch 21, the controller 6 may determine that it is necessary to exchange the input character for the exchange candidate character.

In the above, it is described that the area number of the exchange candidate character areas 34b to 34d is set to “3” and the three exchange candidate characters are simultaneously displayed. However, the area number of the exchange candidate character areas 34b to 34d may be set to “4” or more, and the four or more exchange candidate characters may be simultaneously displayed.

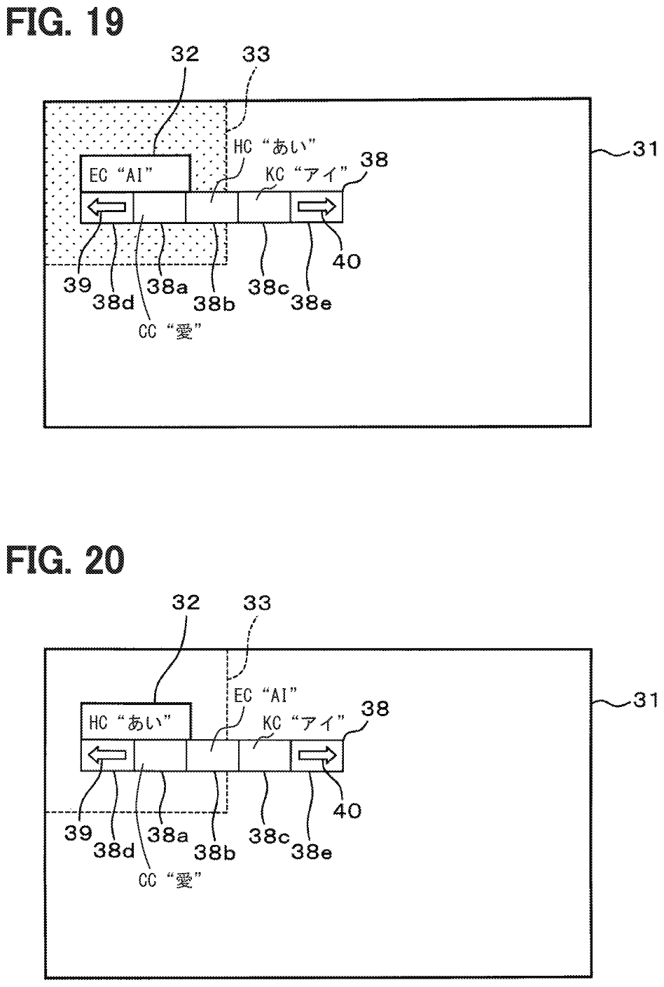

In the above, it is described that the exchange candidate screen 34 is display at the substantial central part of the character input screen 31. However, as shown in FIG. 19, an exchange candidate screen 38 may be displayed just below the character display field 32. The exchange candidate screen 38 may correspond to a simple screen more than the exchange candidate screen 34. The exchange candidate screen 38 includes exchange candidate character areas 38a to 38c (corresponding to the exchange candidate display fields), and scroll areas 38d and 38e. The controller 6 displays the CC “ [symbol] ”, the HC “ [symbol] ”, and the KC “ [symbol] (in two byte character)” as the exchange candidate character in the exchange candidate character areas 38a to 38c, displays a left arrow icon 39 in the scroll area 38d, and displays a right arrow icon 40 in the scroll area 38e.

This case is similarly to a case where the exchange candidate screen 34 is displayed. It is assumed that the area to which the gaze direction of the user is directed corresponds to the exchange candidate character area 38b, as shown in FIG. 20. The controller 6 selects the HC “ [symbol] ” belonging to the exchange candidate character area 38b as the exchange target character, and exchanges the EC “AI (in one byte character)” of the character displayed in the character display field 32 for the HC “ [symbol] ”. When the area to which the gaze direction of the user is directed corresponds to the scroll areas 38d and 38e, the controller 6 scrolls the exchange target character belonging to the exchange candidate character areas 38a to 38c.

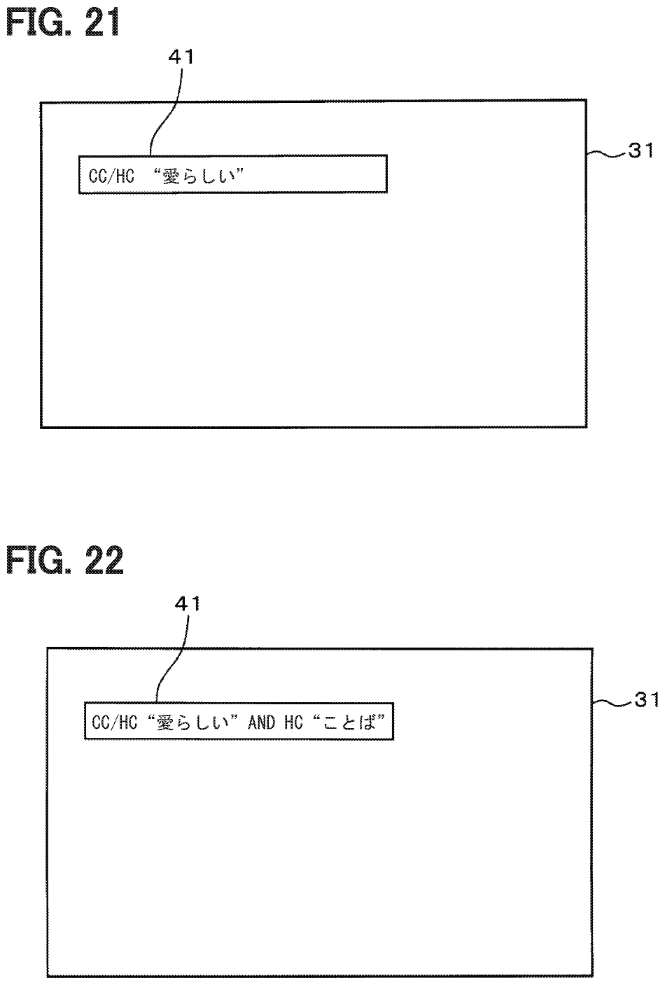

A clause in a sentence may be set to a unit. The controller 6 may determine whether it is necessary to present the exchange candidate character, and determine whether it is necessary to exchange the input character for the exchange candidate character. That is, as shown in FIG. 21, when the operation acceptance section 16 accepts a CC/HC “ [symbol] ” by the operation of the character input by the user, the controller 6 displays the accepted CC/HC “ [symbol] ” in the character display field 41. As shown in FIG. 22, when the operation acceptance section 16 accepts a HC “ [symbol] [symbol] ”, the controller 6 displays the accepted HC “ [symbol] ” following to the CC/HC “ [symbol] [symbol] ” in the character display field 41. The CC/HC “ [symbol] ” means, for example, “Lovely”. A combination of the Chinese character and the hiragana character may be referred to as the CC/HC. The HC “ [symbol] ” means, for example, “Word”.

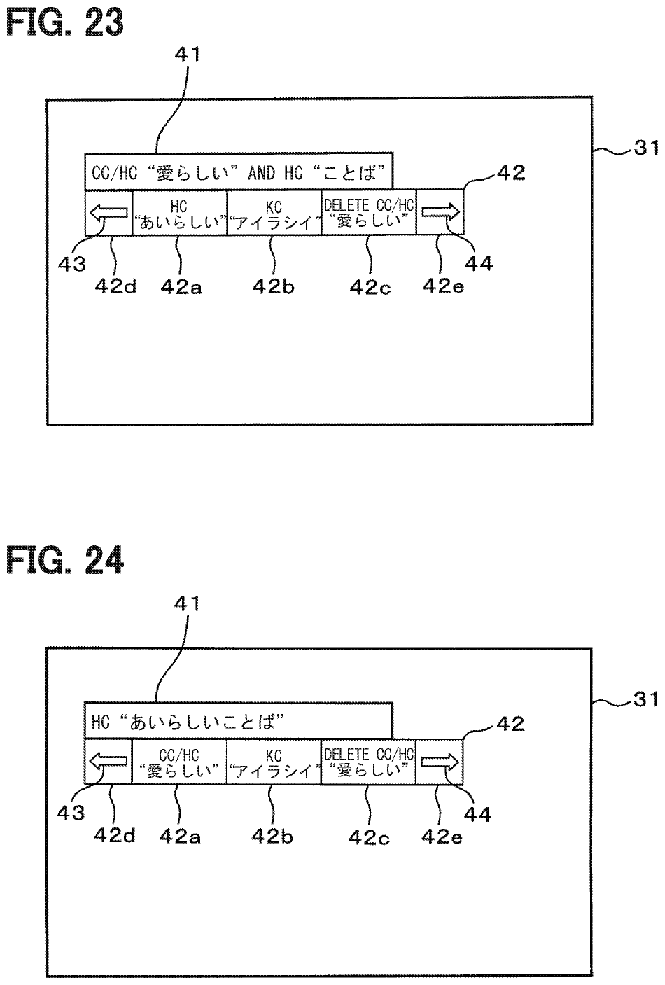

Upon determining that at least one of the brain activity data or the behavior data are below the uncomfortable threshold value and that the user feels uncomfortable, the controller 6 determines that it is necessary to present the exchange candidate character. The controller 6 displays the exchange candidate character in accordance with the input character. That is, as shown in FIG. 23, the controller 6 displays an exchange candidate screen 42 just below the character display field 41. The exchange candidate screen 42 includes exchange candidate character areas 42a to 42c (corresponding to an exchange candidate display field), and scroll areas 42d and 42e. The controller 6 displays, as the exchange candidate character in accordance with the CC/HC “ [symbol] ” of the first clause, a HC “ [symbol] [symbol] ”, the KC “ [symbol] ”, and the CC/HC ““DELETE” [symbol] ” in the exchange candidate character areas 42a to 42c. The controller 6 displays a left arrow icon 43 in the scroll area 42d, and displays a right arrow icon 44 in the scroll area 42e. The HC “ [symbol] ”, the “ [symbol] ” have the same pronounce of an English character “AIRASI”.

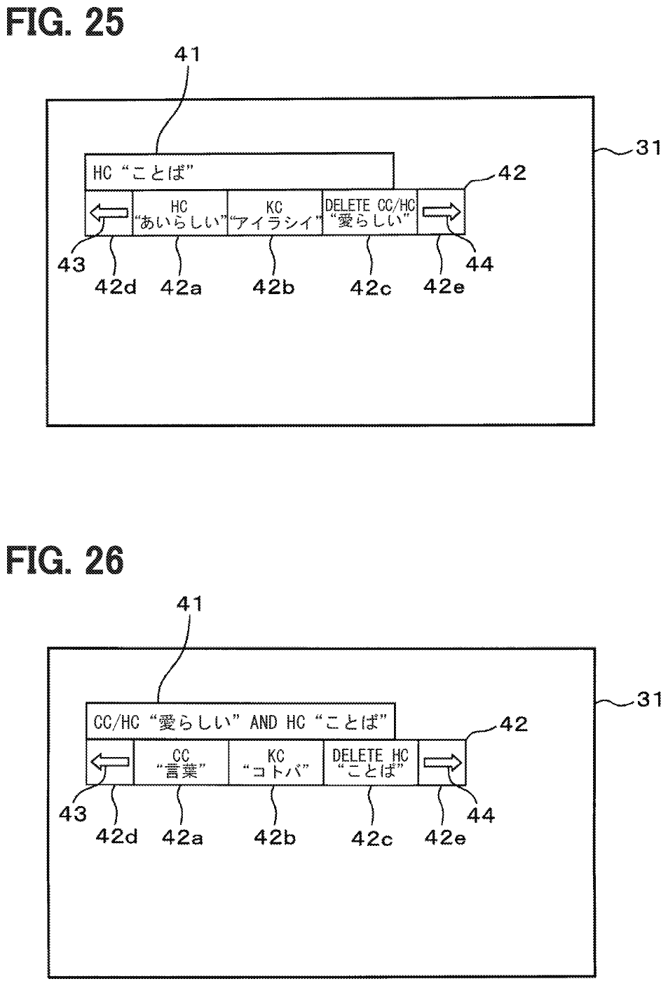

This case is similar to the case where the exchange candidate screen 34 or the exchange candidate screen 38 is displayed. As shown in FIG. 24, it is assumed that the area to which the gaze direction of the user is directed corresponds to the exchange candidate character area 42a. The controller 6 selects the CC/HC “ [symbol] [symbol] ” belonging to the exchange candidate character area 42a as the exchange target character, and exchanges the CC/HC “ [symbol] ” of the character displayed in the character display field 41 for the HC “ [symbol] ”. As shown in FIG. 25, the controller 6 deletes the CC/HC “ [symbol] ” displayed in the character display field 41 when the area to which the gaze direction of the user is directed corresponds to the exchange candidate character area 42c.

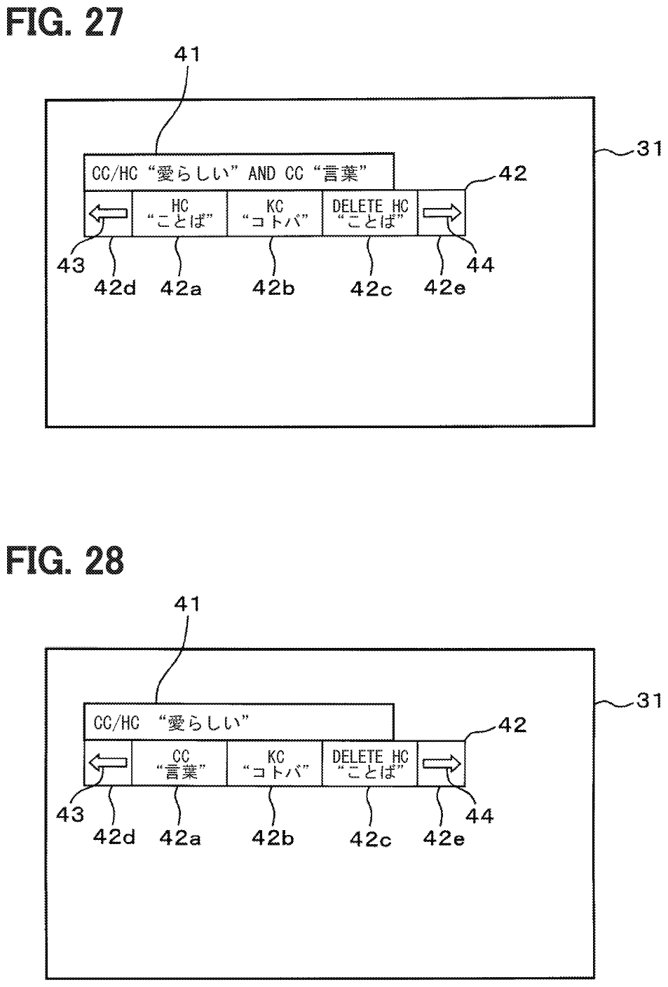

As shown FIG. 26, the controller 6 displays, as the exchange candidate character in accordance with the HC “ [symbol] ” of the next clause, a CC “ [symbol] ”, a KC “ [symbol] ”, and the “HC ““DELETE” [symbol] ” in the exchange candidate character areas 42a to 42c. As shown in FIG. 27, it is assumed that the area to which the gaze direction of the user is directed corresponds to the exchange candidate character area 42a. The controller 6 selects the CC “ [symbol] ” belonging to the exchange candidate character area 42a as the exchange target character, and exchanges the HC “ [symbol] ” of the character displayed in the character display field 41 for the CC “ [symbol] ”. [symbol] ”. As shown in FIG. 28, the controller 6 deletes the HC “ [symbol] ” displayed in the character display field 41 when the area to which the gaze direction of the user is directed corresponds to the exchange candidate character area 42c. The CC “ [symbol] ” means, for example, “Word”. The HC “ [symbol] ”, the “ [symbol] ”, the CC “ [symbol] ” have the same pronounce of an English character “KOTOBA”.

The embodiment described above can provide effects as below. In the electronic information process system 1, a case where the character which is intended by the user is input and a case where the character which is not intended by the user are different in the brain activity of the user or the behavior of the user, when the user performs the character input operation. When the user performs the character input operation, the electronic information process system 1 determines whether it is necessary to present the exchange candidate character in accordance with the input character based on the detection results of the brain activity of the user and the behavior of the user that are detected after the character input operation. The electronic information process system 1 displays the exchange candidate character. The electronic information process system 1 determines whether it is necessary to exchange the input character for the exchange candidate character based on the gaze direction of the user, the detection results of the brain activity of the user and the behavior of the user. The electronic information process system 1 selects the exchange target character from the exchange candidate characters, and confirms the selected exchange target character as the confirmation character.

It may be possible to select, as the exchange target character, the character intended by the user from the exchange candidate characters and confirm the selected character as the confirmation character by only changing the gaze direction of the user, even when the user does not change the character input type or does not perform the character input operation again. Thereby, it may be possible to improve the convenience when the user performs the character input operation. This case is different from a case of using changes of the magnetic field or the electric field in time series, the magnetic field or the electric field being generated by the working of the word center. This case does not require a large amount of process time and is suitable for the character input operation including a large amount of characters since this case uses differences of the brain activity of the user.

When the electronic information process system 1 selects the exchange target character from the exchange candidate characters, the electronic information process system 1 displays the exchange target character instead of the input character in the character display field 32. The electronic information process system 1 confirms, as the confirmation character, the exchange target character displayed in the character display field 32. It may be possible to appropriately allow the user to grasp exchanging of the input character and the exchange target character by displaying the exchange target character instead of the input character in the character display field 32.

The electronic information process system 1 determines that it is necessary to exchange the input character for the exchange candidate character and selects the specific character as the exchange target character when the state where the gaze direction of the user is directed to the specific character and also the brain activity of the user are not uncomfortable continues for the predetermined time. It may be possible to easily determine whether it is necessary to exchange the input character for the exchange candidate character by determining a time (or term) when the gaze direction of the user is directed to the specific character.

The electronic information process system 1 determines whether it is necessary to present the exchange candidate character in accordance with the input character based on the detection result of the voice uttered by the user or the detection result of the operation by the user in addition to the detection results of the brain activity of the user or the behavior of the user. It may be possible to present the exchange candidate character by the utterance of the voice by the user or the operation of the hand switch 21 by the user even when the detection result for the brain activity of the user or the detection result for the behavior of the user is uncertain. The electronic information process system 1 determines whether it is necessary to exchange the input character for the exchange candidate character based on the detection result of the voice uttered by the user or the detection result of the operation by the user in addition to the detection result of the brain activity for the user or the detection result of the behavior for the user. It may be possible to exchange the input character for the exchange candidate character by the utterance of the voice by the user or the operation of the hand switch 21 by the user even when the detection result for the brain activity of the user or the detection result for the behavior of the user is uncertain.

The electronic information process system 1 displays the exchange candidate character in a state where the input character is displayed in the character display field 32. It may be possible to allow the user to simultaneously grasp the input character and the exchange candidate character. It may be possible to allow the user to appropriately select the exchange target character while comparing with the input character. The electronic information process system 1 simultaneously displays the multiple exchange candidate characters. It may be possible to appropriately select the exchange target character while comparing the multiple exchange candidate characters.

Upon determining that it is unnecessary to present the exchange candidate character, the electronic information process system 1 confirms the input character displayed in the character display field 32 as the confirmation character. When the character accepted by the character input operation by the user corresponds to the intended character, it may be possible to confirm the input character as the confirmation character without changing the input character.

Although the present disclosure has been described in accordance with the embodiments, it is understood that the present disclosure is not limited to the embodiments and structures. The present disclosure may cover various modification examples and equivalent scopes. In addition, while the various elements are shown in various combinations and configurations, which are exemplary, other combinations and configurations, including more, less or only a single element, are also within the spirit and scope of the present disclosure.

The present disclosure may be not limited to the configuration applied to the in-vehicle but also another configuration.

In the embodiment, the NIRS technique is employed as the technique of detecting the brain activity of the user. However, the other technique may be employed.

In the embodiment, both of the detection result of the brain activity detection section 8 and the detection result of the behavior detection section 9 are used. However, based on only the detection result of the brain activity detection section 8, the electronic information process system 1 may determine whether it is necessary to present the exchange candidate character or whether it is necessary to exchange the input character for the exchange candidate character.

Layouts of the character input screen and the exchange candidate screen may correspond to layouts other than the exemplified layouts.

1. An electronic information process system comprising:
an operation acceptance section configured to accept a character input operation by a user;
a brain activity detection section configured to detect a brain activity of the user;
a gaze direction detection section configured to detect a gaze direction of the user;
a first display controller configured to display an accepted character as an input character in a character display field, when the character input operation by the user is accepted;
a presentation necessity determination section configured to determine whether a presentation of at least one of a plurality of exchange candidate characters in accordance with the input character is necessary, based on a detection result of the brain activity detection section that is detected after the accepted character by the character input operation by the user is displayed as the input character;
a second display controller configured to display the plurality of exchange candidate characters in at least one of a plurality of exchange candidate display fields when the presentation necessity determination section determines that the presentation of the exchange candidate characters is necessary;
an exchange necessity detection section configured to
determine whether an exchange of the input character for the exchange candidate character is necessary, and
select an exchange target character from the exchange candidate characters when determining that the exchange of the input character for the exchange candidate character is necessary; and
a character confirmation section configured to confirm the selected exchange target character as a confirmation character when the exchange target character is selected from the exchange candidate characters.

2. The electronic information process system according to claim 1, further comprising:
a third display controller configured to display the exchange target character instead of the input character in the character display field, when the exchange necessity detection section determines that the exchange of the input character for the exchange candidate character is necessary and selects the exchange target character from the exchange candidate characters,
wherein:
the character confirmation section confirms the exchange target character displayed in the character display field as the confirmation character.

3. The electronic information process system according to claim 1, wherein:
when a state where the gaze direction of the user is directed to a specific character of the exchange candidate characters and also the brain activity of the user is not uncomfortable continues for a predetermined time, the exchange necessity determination section determines that the exchange of the input character is necessary, and selects the specific character as the exchange target character.

4. The electronic information process system according to claim 1, further comprising:
at least one of a behavior detection section configured to detect a behavior of the user, a voice detection section configured to detect a voice uttered by the user, or an operation detection section configured to detect an operation by the user,
wherein:
the presentation necessity determination section determines whether the presentation of the exchange candidate character in accordance with the input character is necessary based on at least one of a detection result of the behavior detection section, a detection result of the voice detection section, or a detection result of the operation detection section, in addition to the detection result of the brain activity detection section that is detected after the accepted character by the character input operation by the user is displayed as the input character;

5. The electronic information process system according to claim 1, further comprising:
at least one of a behavior detection section configured to detect a behavior of the user, a voice detection section configured to detect a voice uttered by the user, or an operation detection section configured to detect an operation by the user,
wherein:
the exchange necessity determination section determines whether the exchange of the input character for the exchange candidate character is necessary based on at least one of a detection result of the behavior detection section, a detection result of the voice detection section, or a detection result of the operation detection section, in addition to the detection result of the gaze direction detection and the detection result of the brain activity detection section that are detected after the exchange candidate character is displayed; and
the exchange necessity determination section selects the exchange target character from the exchange candidate characters when determining that the exchange of the input character for the exchange candidate character is necessary.

6. The electronic information process system according to claim 1, wherein:
the second display controller displays the exchange candidate character in the exchange candidate character display field in a state where the input character is displayed in the character display field.

7. The electronic information process system according to claim 1, wherein:
the second display controller simultaneously displays the exchange candidate characters in the exchange candidate character display field.

8. The electronic information process system according to claim 1, wherein:
the second display controller scrolls the exchange candidate characters in the exchange candidate display field.

9. The electronic information process system according to claim 1, wherein:
When the presentation necessity determination section determines the presentation of the exchange candidate character is unnecessary, the character confirmation section confirms the input character displayed in the character display field as the confirmation character.

10. A computer-readable non-transitory storage medium storing instructions for execution by a computer for an electronic information process system that includes an operation acceptance section configured to accept a character input operation by a user, a brain activity detection section configured to detect a brain activity of the user, and a gaze direction detection section configured to detect a gaze direction of the user, the instructions configured to cause a controller of the electronic information process system to:
accept the character input operation by the user;
display an accepted character as an input character in a character display field when the character input operation by the user is accepted;
determine whether a presentation of at least one of a plurality of exchange candidate characters in accordance with the input character is necessary, based on a detection result of the brain activity detection section that is detected after the accepted character by the character input operation by the user is displayed as the input character;
display the plurality of exchange candidate characters in at least one of a plurality of exchange candidate display fields when determining the presentation of the exchange candidate characters is necessary;
determine whether an exchange of the input character for the exchange candidate character is necessary, and
select an exchange target character from the exchange candidate characters when determining that the exchange of the input character for the exchange candidate character is necessary; and
confirm the selected exchange target character as a confirmation character when selecting the exchange target character from the exchange candidate characters.

11. The electronic information process system according to claim 3, further comprising:
a database that stores brain activity data,
wherein:
the brain activity detection section sets a predetermined threshold based on the brain activity data; and
when a value of the brain activity data is equal to or higher than the predetermined threshold, the brain activity detection section detects that the brain activity of the user is not uncomfortable.

12. The electronic information process system according to claim 1, wherein:
the brain activity detection section detects the brain activity of the user by detecting hemoglobin concentration in a brain of the user.
